(19) United States
(12) Patent Application Publication
(10) Pub. No.: US 2025/0341696 A1
(43) Pub. Date: Nov. 6, 2025

(54) EXTENDER CONFIGURED TO MOUNT AN ENCLOSURE SPACED APART FROM A MOUNTING SURFACE TO PROVIDE SPACE FOR SLACK CABLE STORAGE

(71) Applicant: PPC BROADBAND, INC., East Syracuse, NY (US)

(72) Inventors: Gabriel OSEI, East Syracuse, NY (US); Jordan CAVINESS, Liverpool, NY (US)

(73) Assignee: PPC BROADBAND, INC., East Syracuse, NY (US)

(21) Appl. No.: 19/197,517

(22) Filed: May 2, 2025

Related U.S. Application Data
(60) Provisional application No. 63/642,023, filed on May 3, 2024.

(51) Int. Cl. G02B 6/44

(52) U.S. Cl. CPC G02B 6/4446

(57) ABSTRACT

An extender structurally configured to attach to a communication system enclosure to position the enclosure spaced apart from a mounting surface so as to provide space for slack cable storage between a back wall portion of the enclosure and the mounting surface. The extender may include an attachment portion structurally configured to attach to a communication system enclosure, a receiving portion structurally configured to receive a fastener for securing the communication system enclosure to the mounting surface; and a nesting portion structurally configured to allow the body portion to be arranged in a stacked configuration with a second extender.

### CROSS REFERENCE TO RELATED APPLICATIONS

This application claims the benefit of U.S. Provisional Application No. 63/642,023 filed May 3, 2024, which is currently pending, the disclosure of which is hereby incorporated by reference herein in its entirety.

### TECHNICAL FIELD

The present disclosure relates generally to an enclosure for communication cables, and more particularly to an extender configured to mount the enclosure spaced apart from a mounting surface to provide space for slack cable storage.

### BACKGROUND

Fiber optic networks use communication system enclosures that are configured to handle different connectivity solutions (e.g., looped cable storage, splicing, and patching). In some applications, the communication system enclosures are mounted to a wall, to a side of a residence, or other mounting surface. For some applications, the technician or installer needs space between the back of the enclosure and the mounting surface to store excess cable. In some instances, however, there may not be sufficient space between the enclosure and the mounting surface once the enclosure is securely mounted.

There is a need for a simple and convenient solution for mounting a communication system enclosure to a mounting surface such that there is sufficient space between the enclosure and the mounting surface to store excess cable. Accordingly, it may be desirable to provide an extender or spacer that is structurally configured to attach to the back of the enclosure and permit mounting the enclosure spaced apart from the mounting surface such that there is sufficient space between the back of the enclosure and the mounting surface to store excess or slack cable.

### SUMMARY

The present disclosure provides an extender structurally configured to attach to a communication system enclosure to position the enclosure spaced apart from a mounting surface to provide space for slack cable storage. In some implementations, the extender may be structurally configured to mount the communication system enclosure to the mounting surface with sufficient space between the back wall of the communication system enclosure and the mounting surface so as to provide space to store slack cable.

In some embodiments, the extender may include a body portion having a proximal end portion and a distal end portion opposite the proximal end portion. In some embodiments, the distal end portion may be structurally configured to engage a mounting surface.

In some embodiments, the extender may include an attachment portion structurally configured to attach the proximal end portion to a communication system enclosure. In some embodiments, the extender may include a receiving portion extending between the proximal end portion and the distal end portion. In some embodiments, the receiving portion may be structurally configured to receive a fastener for securing the communication system enclosure to the mounting surface.

In some embodiments, the extender may include a nesting portion structurally configured to allow the body portion to be arranged in a stacked configuration with a second extender.

In some embodiments, the extender may be structurally configured to mount the communication system enclosure to the mounting surface with sufficient space between a back wall portion of the communication system enclosure and the mounting surface so as to provide space to store slack cable between the back wall portion and the mounting surface.

In some embodiments, the attachment portion may be structurally configured to attach to the communication system enclosure by a friction fit. In some embodiments, the attachment portion may include a flexible engagement portion structurally configured to engage a projecting portion of the communication system enclosure. In some embodiments, the flexible engagement portion may include a plurality of flexible longitudinally extending ridges structurally configured to engage the projecting portion.

In some embodiments, the extender may include a fastener retention portion structurally configured to hold a stored fastener on an exterior surface portion of the body portion. In some embodiments, the fastener retention portion may be structurally configured to engage the stored fastener at multiple locations and on opposite sides of the stored fastener.

In some embodiments, the nesting portion may include a recessed portion adjacent the proximal end portion that is structurally configured to receive at least a portion of the second extender.

In some embodiments, the receiving portion may define a passage extending through the body portion along a longitudinal axis from the proximal end portion to the distal end portion.

In some embodiments, the body portion may be monolithic.

In some embodiments, the extender may be structurally configured to attach to a communication system enclosure to position the enclosure spaced apart from a mounting surface to provide space for slack cable storage.

In some embodiments, the extender may include a body portion having a proximal end portion, a distal end portion opposite the proximal end portion, and an intermediate portion extending along a longitudinal axis between the proximal end portion and the distal end portion. In some embodiments, the distal end portion may be structurally configured to engage a mounting surface.

In some embodiments, the extender may include an attachment portion structurally configured to attach the proximal end portion to a communication system enclosure.

In some embodiments, the extender may include a receiving portion extending between the proximal end portion and the distal end portion and structurally configured to receive a fastener for securing the communication system enclosure to the mounting surface.

In some embodiments, the extender may include a nesting portion structurally configured to allow the body portion to be arranged in a stacked configuration with a second extender, wherein the nesting portion includes a recessed portion structurally configured to receive at least a portion of the second extender.

In some embodiments, the extender may include a fastener retention portion structurally configured to hold a stored fastener on an exterior surface portion of the body portion.

In some embodiments, the extender may be structurally configured to mount the communication system enclosure to the mounting surface with sufficient space between a back wall portion of the communication system enclosure and the mounting surface so as to provide space to store slack cable.

In some embodiments, the attachment portion may be structurally configured to attach to the communication system enclosure by a friction fit.

In some embodiments, the attachment portion may include a flexible engagement portion configured to extend along an inner surface defining at least a section of the receiving portion.

In some embodiments, the fastener retention portion may be structurally configured to engage the stored fastener at multiple locations on two sides of the stored fastener.

In some embodiments, an extender may be structurally configured to attach to a communication system enclosure to position the enclosure spaced apart from a mounting surface so as to provide space for slack cable storage.

In some embodiments, the extender may include a body portion having a proximal end portion and a distal end portion opposite the proximal end portion. In some embodiments, the distal end portion may be structurally configured to engage a mounting surface.

In some embodiments, the extender may include an attachment portion structurally configured to attach the proximal end portion to a communication system enclosure.

In some embodiments, the extender may include a receiving portion extending between the proximal end portion and the distal end portion. In some embodiments, the receiving portion may be structurally configured to receive a fastener for securing the communication system enclosure to the mounting surface.

In some embodiments, the extender may include a nesting portion structurally configured to allow the body portion to be arranged in a stacked configuration with a second extender.

In some embodiments, the attachment portion may include a flexible engagement portion structurally configured to engage a projecting portion of the communication system enclosure to attach to the communication system enclosure by a friction fit.

In some embodiments, the extender may be structurally configured to mount the communication system enclosure to the mounting surface with sufficient space between a back wall portion of the communication system enclosure and the mounting surface so as to provide space to store slack cable.

In some embodiments, the flexible engagement portion may include a plurality of flexible longitudinally extending ridges structurally configured to engage the projecting portion.\

In some embodiments, the fastener retention portion may be structurally configured to hold a stored fastener on an exterior surface portion of the body portion.

In some embodiments, the fastener retention portion may be structurally configured to engage the stored fastener at multiple locations and on opposite sides of the stored fastener.

In some embodiments, the nesting portion may include a recessed portion adjacent the proximal end portion that is structurally configured to receive at least a portion of the second extender.

In some embodiments, the receiving portion may define a passage extending through the body portion along a longitudinal axis from the proximal end portion to the distal end portion.

In some embodiments, the body portion may be monolithic.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 is a bottom perspective view of an exemplary extender in accordance with various aspects of the disclosure attached to a communication system enclosure.

FIG. 2 is a side section view of the extender and communication system enclosure of FIG. 1.

FIG. 3 is a side view of the extender of FIG. 1.

FIG. 4 is a front view of the extender of FIG. 1.

FIG. 5 is a side section view of the extender of FIG. 1.

FIG. 6 is a top view of the extender of FIG. 1.

FIG. 7 is an enlarged side view of the extender of FIG. 1 showing an exemplary fastener retention portion.

FIG. 8 is a side view of the extender of FIG. 1 stacked in a nested or stacked configuration with a second extender.

FIG. 9 is a side section view of the extender of FIG. 1 stacked in a nested or stacked configuration with a second extender.

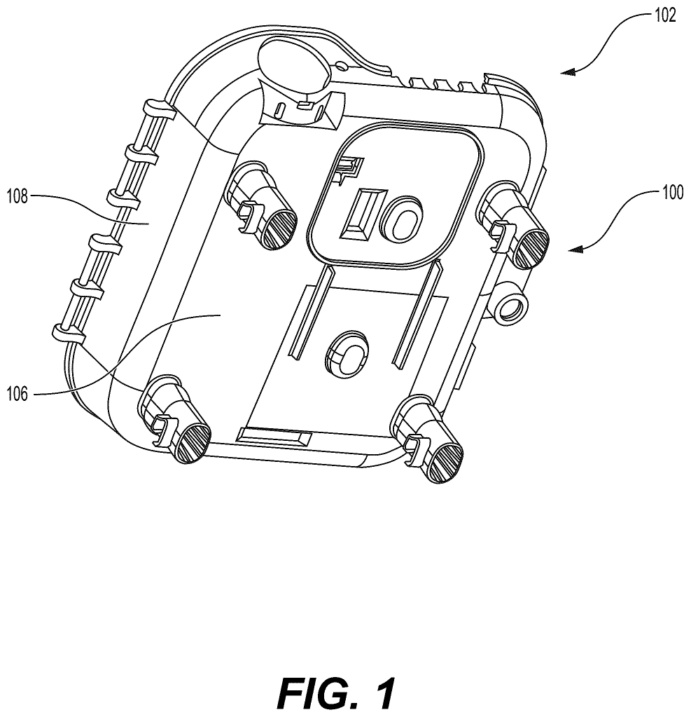

### DETAILED DESCRIPTION

Reference will now be made in detail to presently preferred embodiments and methods of the present disclosure, which constitute the best modes of practicing the present disclosure presently known to the inventors. The figures are not necessarily to scale. It is to be understood, however, that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Implementations of the disclosure provide an extender 100 for mounting a communication system enclosure 102 for providing connectivity solutions (e.g., looped cable storage, splicing, and patching) for communication cable (e.g., fiber optic cable, copper coaxial cable, etc.) to a mounting surface 104 while providing sufficient space between the communication system enclosure 102 and the mounting surface 104 to store excess cable. The communication system enclosure 102 may be configured in a variety of ways, including size, shape, materials, etc. The communication system enclosure 102 may be an enclosure that is structurally configured to handle different connectivity solutions (e.g., looped cable storage, splicing, and patching). In some implementations, the communication system enclosure 102 may be a house box that functions as a residential demarcation enclosure to house fiber optic cables and mount at or near a house or business of a subscriber.

In the illustrated implementation, the communication system enclosure 102 may include a back wall 106 and one or more sidewalls 108 extending from the back wall 106 to define a cavity or interior space 110. The communication system enclosure 102 may include a cover or lid (not shown) that covers the interior space 110. In the illustrated implementation, the communication system enclosure 102 may be generally a square box shape. The communication system enclosure 102, however, may be any suitable shape.

The communication system enclosure 102 may be structurally configured to mount to the mounting surface 104. In some implementations, the communication system enclosure 102 may include a mounting portion 112. In some implementations, the mounting portion 112 may include a plurality of projections or feet 114 (e.g., four feet) extending outward from the back wall 106 of the communication system enclosure 102. The projections or feet 114 may be arranged in a variety of ways. In some implementations, each projection or foot 114 may be generally arranged at or adjacent to a corresponding corner 118 of the back wall 106.

Each projection or foot 114 may have a distal end 120 and a longitudinal passage 122. In use, the communication system enclosure 102 may be positioned such that the distal end 120 of each of the feet 114 engages the mounting surface 104 and a corresponding fastener (e.g., a screw) (not shown) may be received from the interior space 110 through the longitudinal passage 122 and driven into the mounting surface 104 to attach the communication system enclosure 102 to the mounting surface 104.

In some applications, it may be desirable to have a greater distance D between the back wall 106 and the mounting surface 104 when the communication system enclosure 102 is mounted than is present when the communication system enclosure 102 is mounted directly to the mounting surface 104 by the feet 114. For example, when it is desirable to store excess cable between the communication system enclosure 102 and the mounting surface 104. The extender 100 may be structurally configured to mount the communication system enclosure 102 spaced apart from the mounting surface 104 with increased distance D.

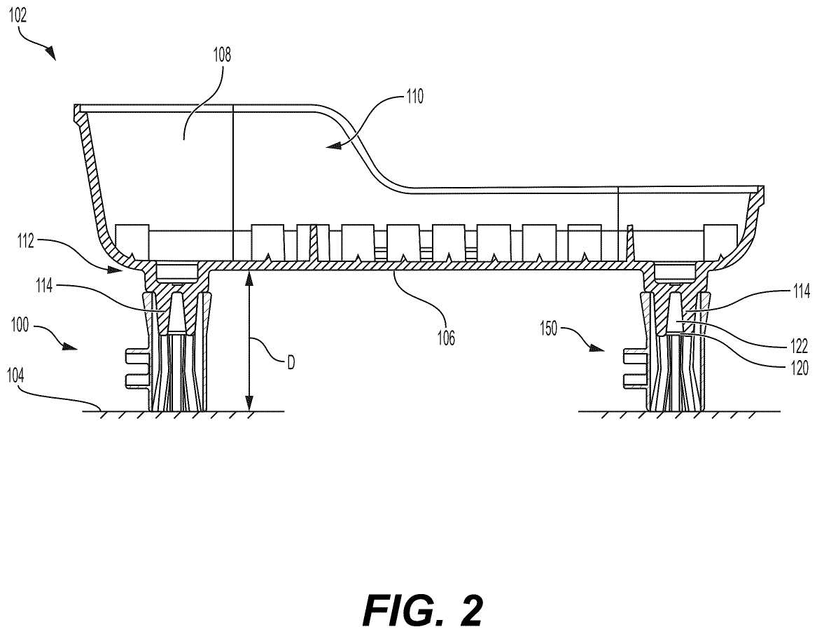

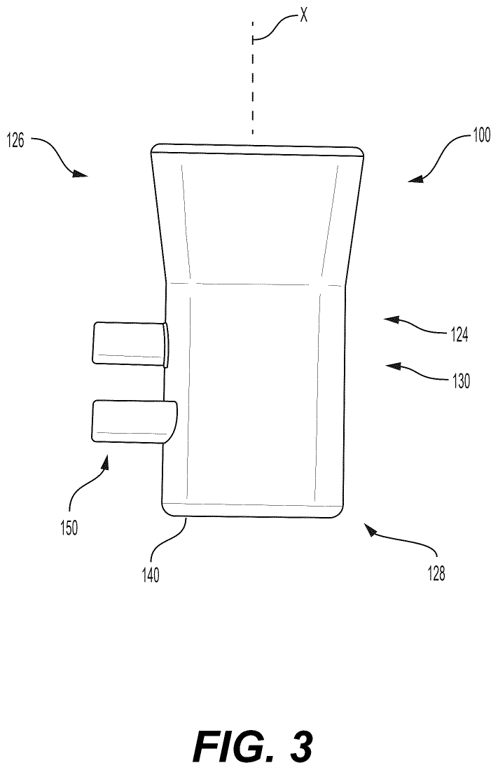

The extender 100 may be configured in a variety of ways, including different shapes, sizes, materials, etc. Referring to FIGS. 2-6, in some implementations, the extender 100 may include a body portion 124 having a proximal end portion 126, a distal end portion 128 opposite the proximal end portion 126, and an intermediate portion 130 extending along a longitudinal axis X between the proximal end portion 126 and the distal end portion 128. In some embodiments, the extender 100 may be monolithic (i.e., formed as a single piece).

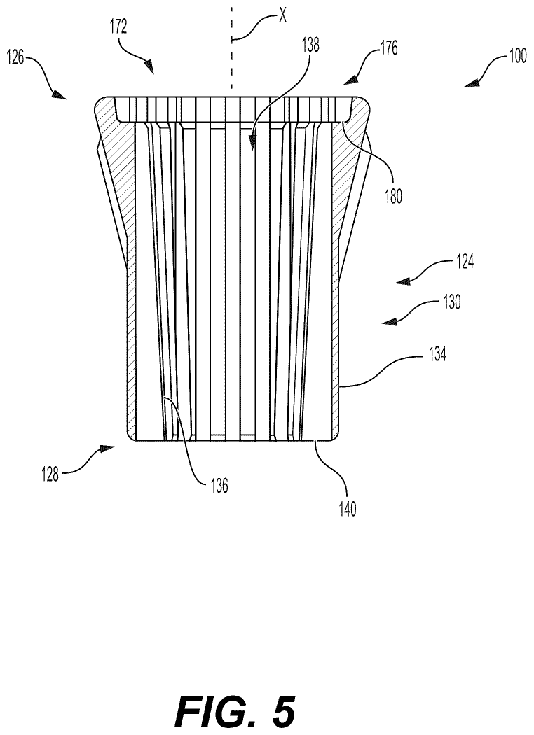

In some implementations, the body portion 124 may include a sidewall 132 having an outer surface 134 and an inner surface 136 (FIG. 5) opposite the outer surface 134. In some implementations, the inner surface 136 may generally parallel to the outer surface 134. In other implementations, however, the inner surface 136 may not extend parallel to the outer surface 134. In some implementations, the outer surface 134 defines an oval shaped cross section. In other implementations, the cross-section shape of the body portion 124 may be any suitable shape (e.g., circular, rectangular, triangular, etc.). In some implementations, the outer surface 134 of at least a portion of the proximal end portion 126 may flare outward.

In some implementations, the inner surface 136 defines a receiving portion 138 (e.g., a passage) extending through the body portion 124 along the longitudinal axis X from the proximal end portion 126 to the distal end portion 128. In some implementations, the receiving portion 138 may be structurally configured to receive a fastener (not shown) for securing the communication system enclosure 102 to the mounting surface 104.

In some implementations, the distal end portion 128 may be structurally configured to engage the mounting surface 104. For example, in some implementations, the distal end portion 128 may include an engagement surface 140 extending traverse (e.g., perpendicular) to the outer surface 134 of the sidewall 132.

In some implementations, the extender 100 may include an attachment portion 142 structurally configured to attach to the communication system enclosure 102. The attachment portion 142 may be structurally configured in a variety of ways. For example, in some implementations, the attachment portion 142 may be located at or adjacent to the proximal end portion 126. The attachment portion 142 may be structurally configured to attach to the communication system enclosure 102 in any suitable manner.

In some implementations, the attachment portion 142 may be structurally configured to attach to the communication system enclosure 102 by a friction fit. For example, in some implementations, the extender 100 may be structurally configured to receive one of the projections or feet 114 within the receiving portion 138. In some implementations, the longitudinal passage 122 of the projection or foot 114 may be coaxial with the receiving portion 138 of the extender 100 when the projection or foot 114 is received within the receiving portion 138.

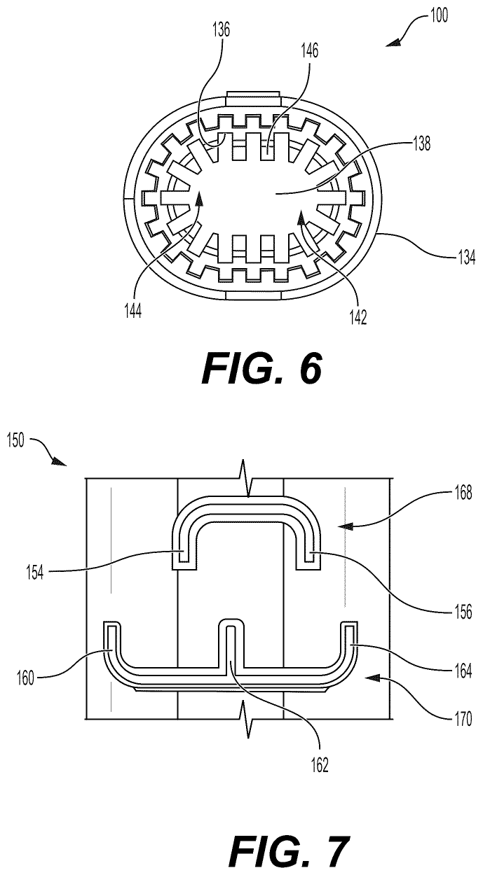

The attachment portion 142 may be structurally configured to resist the projection or foot 114 being decoupled from the extender 100 once attached. In some implementations, the attachment portion 142 may include a flexible engagement portion 144 (FIG. 6) extending along the inner surface 136 of at least a portion of the receiving portion 138. The flexible engagement portion 144 may be configured in a variety of ways. In some implementations, the flexible engagement portion 144 may include a plurality of flexible longitudinally extending ridges or ribs 146 that may be structurally configured to engage the projection or foot 114 when received within the receiving portion 138. The flexible longitudinally extending ridges or ribs 146 may deform when engaged by the projection or foot 114 to create the friction fit.

As shown in FIG. 2, when an extender 100 is attached to each foot 114 of the communication system enclosure 102, that communication system enclosure 102 may be mounted to the mounting surface 104 with an increased distance D between the back wall 106 and the mounting surface 104 than without extenders. As a result, the additional space may be used to store excess cable between the back wall 106 and the mounting surface 104. To mount the communication system enclosure 102 to the mounting surface 104, the communication system enclosure 102 with the extenders 100 attached may be positioned such that the engagement surface 140 of each of the extenders 100 engages mounting surface 104 and a corresponding fastener (e.g., a screw) (not shown) may be received from the interior space 110 through the longitudinal passage 122 of the feet 114 of the communication system enclosure 102 and the receiving portion 138 of the extender 100 and driven into the mounting surface 104 to attach the communication system enclosure 102 to the mounting surface 104.

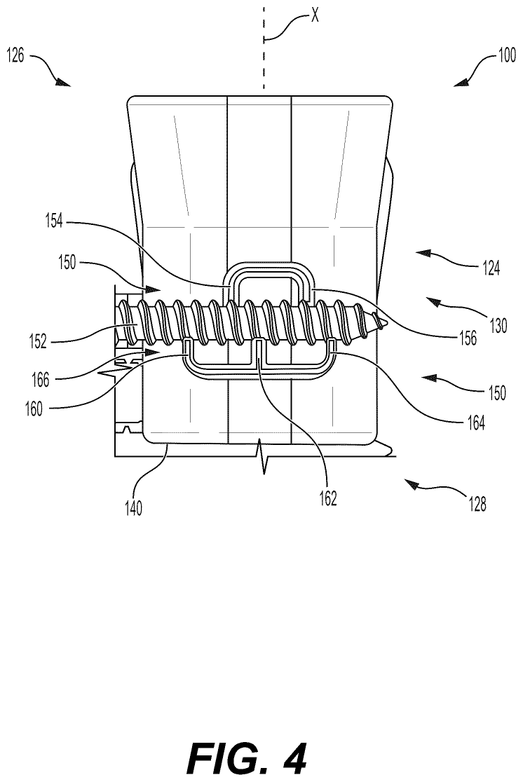

Referring to FIGS. 4 and 7, in some implementations, the extender 100 may include a fastener retention portion 150 structurally configured to hold a stored fastener 152 (e.g., a fastener intended to be used to secure the communication system enclosure 102 to the mounting surface once the extender 100 is attached to the communication system enclosure 102). The stored fastener 152, in some implementations, may be a screw, bolt, or similar fastener. In some implementations, the fastener retention portion 150 may be structurally configured to secure slack or unused communication cable 12 when not used to hold the stored fastener 152.

The fastener retention portion 150 may be structurally configured in a variety of ways. In some implementations, the fastener retention portion 150 may be positioned on the outer surface 134 of the body portion 124 such that the stored fastener 152 or slack communication cable 12 is held against or adjacent the outer surface 134.

In some implementations, the fastener retention portion 150 may be structurally configured to engage the stored fastener 152 at multiple spaced-apart locations on opposite sides of the stored fastener 152. For example, in some implementations, the fastener retention portion 150 may include a first fastener engagement portion 154 and a second fastener engagement portion 156 structurally configured to engage the stored fastener 152 on a first side 158 of the stored fastener 152 at spaced apart locations and a third fastener engagement portion 160, a fourth fastener engagement portion 162, and a fifth fastener engagement portion 164 structurally configured to engage the stored fastener 152 on a second side 166 of the stored fastener 152, opposite the first side 158, at spaced apart locations. In some implementations, the first and second engagement portions 154, 156 may be positioned on an upside-down, U-shaped retention portion 168 and the third, fourth, and fifth fastener engagement portions 160, 162, 164 may be positioned on a W-shaped retention portion 170 (FIG. 7).

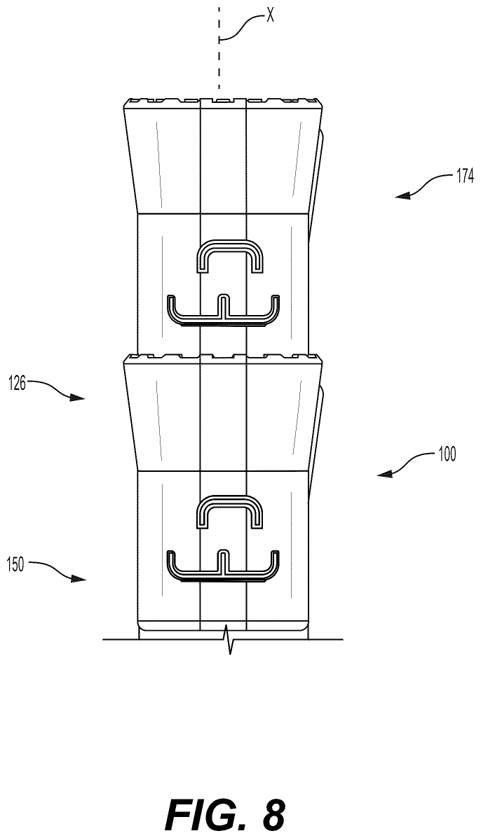

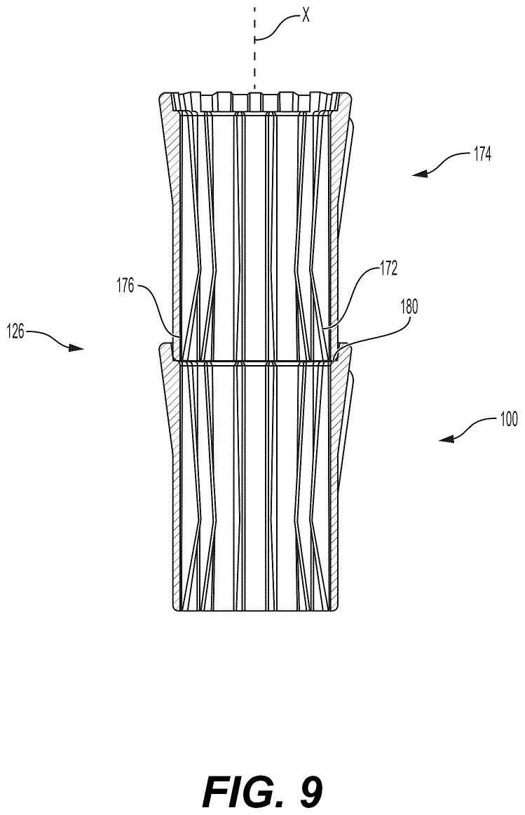

In some implementations, the extender 100 may include a nesting portion 172 (FIGS. 5 and 9) structurally configured to allow the extender 100 and a second extender 174 (e.g., identical or non-identical) to be arranged in a nested or stacked configuration. The nesting portion 172 may be configured in a variety of ways. In some implementations the nesting portion 172 may include a recessed portion 176 structurally configured to receive a portion of the second extender 174, as shown in FIGS. 8-9. In some implementations, the recessed portion 176 defines a radially extending shoulder 180 along the inner surface 136 of the extender 100. In some implementations, the recessed portion 176 may be arranged at, or adjacent to, the proximal end portion 126.

In the illustrated implementation, to place the extender 100 and the second extender 174 in a nested or stacked configuration, a distal end portion 182 (FIG. 9) of the second extender 174 may be received within the recessed portion 176 at the proximal end portion 126 of the extender 100. In some implementations, the extender 100 and the second extender 174 may be coaxially aligned in the nested or stacked configuration. In some implementations, the distal end portion 182 may be held in place in the recessed portion 176 via a friction fit. It will be understood that additional extenders (not shown) may be added to the extender 100 and the second extender 174 in the nested or stacked configuration in the same manner as the extender and the second extender 174 are stacked. The nested or stacked configuration provides the benefit of allowing the multiple extenders to the stored with a smaller footprint than if not nested or stacked.

In addition, in some implementations, the nested or stacked configuration may allow for multiple extenders 100 to be attached in series (i.e., in a nested or stacked configuration) to each foot 114 of the communication system enclosure 102. As a result, the distance D between the back wall 106 and the mounting surface 104 can be further increased as needed to store excess cable between the back wall 106 and the mounting surface 104. The length of the fastener used to secure the communication system enclosure 102 to the mounting surface 104 can be selected as required to accommodate the number of extenders 100 used.

While at least one example, non-limiting embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An extender structurally configured to attach to a communication system enclosure to position the enclosure spaced apart from a mounting surface so as to provide space for slack cable storage comprising:
a body portion having a proximal end portion, a distal end portion opposite the proximal end portion, and an intermediate portion extending along a longitudinal axis between from the proximal end portion and the distal end portion, wherein the distal end portion is structurally configured to engage a mounting surface;
an attachment portion structurally configured to attach the proximal end portion to a communication system enclosure;
a receiving portion extending between the proximal end portion and the distal end portion and structurally configured to receive a fastener for securing the communication system enclosure to the mounting surface;
a nesting portion structurally configured to allow the body portion to be arranged in a stacked configuration with a second extender, wherein the nesting portion includes a recessed portion structurally configured to receive at least a portion of the second extender;
a fastener retention portion structurally configured to hold a stored fastener on an exterior surface portion of the body portion;
wherein the body portion is structurally configured to mount the communication system enclosure to the mounting surface with sufficient space between a back wall portion of the communication system enclosure and the mounting surface so as to provide space to store slack cable between the back wall portion and the mounting surface.

2. The extender of claim 1, wherein the attachment portion is structurally configured to attach to the communication system enclosure by a friction fit.

3. The extender of claim 2, wherein the attachment portion includes a flexible engagement portion configured to extend along an inner surface defining at least a section of the receiving portion.

4. The extender of claim 1, wherein the fastener retention portion is structurally configured to engage the stored fastener at multiple locations on two sides of the stored fastener.

5. An extender structurally configured to attach to a communication system enclosure to position the enclosure spaced apart from a mounting surface so as to provide space for slack cable storage comprising:
a body portion having a proximal end portion and a distal end portion opposite the proximal end portion, wherein the distal end portion is structurally configured to engage a mounting surface;
an attachment portion structurally configured to attach the proximal end portion to a communication system enclosure;
a receiving portion extending between the proximal end portion and the distal end portion and structurally configured to receive a fastener for securing the communication system enclosure to the mounting surface;
a nesting portion structurally configured to allow the body portion to be arranged in a stacked configuration with a second extender;
wherein the attachment portion includes a flexible engagement portion structurally configured to engage a projecting portion of the communication system enclosure to attach to the communication system enclosure by a friction fit; and
wherein the body portion is structurally configured to mount the communication system enclosure to the mounting surface with sufficient space between a back wall portion of the communication system enclosure and the mounting surface so as to provide space to store slack cable between the back wall portion and the mounting surface.

6. The extender of claim 5, wherein the flexible engagement portion includes a plurality of flexible longitudinally extending ridges structurally configured to engage the projecting portion.

7. The extender of claim 5, further comprising a fastener retention portion structurally configured to hold a stored fastener on an exterior surface portion of the body portion.

8. The extender of claim 7, wherein the fastener retention portion is structurally configured to engage the stored fastener at multiple locations and on opposite sides of the stored fastener.

9. The extender of claim 5, wherein the nesting portion includes a recessed portion adjacent the proximal end portion that is structurally configured to receive at least a portion of the second extender.

10. The extender of claim 5, wherein the receiving portion defines a passage extending through the body portion along a longitudinal axis from the proximal end portion to the distal end portion.

11. The extender of claim 5, wherein the body portion comprises a monolithic structure.

12. An extender structurally configured to attach to a communication system enclosure to position the enclosure spaced apart from a mounting surface so as to provide space for slack cable storage comprising:
a body portion having a proximal end portion and a distal end portion opposite the proximal end portion, wherein the distal end portion is structurally configured to engage a mounting surface;
an attachment portion structurally configured to attach the proximal end portion to a communication system enclosure;
a receiving portion extending between the proximal end portion and the distal end portion and structurally configured to receive a fastener for securing the communication system enclosure to the mounting surface;
a nesting portion structurally configured to allow the body portion to be arranged in a stacked configuration with a second extender; and
wherein the body portion is structurally configured to mount the communication system enclosure to the mounting surface with sufficient space between a back wall portion of the communication system enclosure and the mounting surface so as to provide space to store slack cable between the back wall portion and the mounting surface.

13. The extender of claim 12, wherein the attachment portion is structurally configured to attach to the communication system enclosure by a friction fit.

14. Th extender of claim 13, wherein the attachment portion includes a flexible engagement portion structurally configured to engage a projecting portion of the communication system enclosure.

15. The extender of claim 14, wherein the flexible engagement portion includes a plurality of flexible longitudinally extending ridges structurally configured to engage the projecting portion.

16. The extender of claim 12, further comprising a fastener retention portion structurally configured to hold a stored fastener on an exterior surface portion of the body portion.

17. The extender of claim 16, wherein the fastener retention portion is structurally configured to engage the stored fastener at multiple locations and on opposite sides of the stored fastener.

18. The extender of claim 12, wherein the nesting portion includes a recessed portion adjacent the proximal end portion that is structurally configured to receive at least a portion of the second extender.

19. The extender of claim 12, wherein the receiving portion defines a passage extending through the body portion along a longitudinal axis from the proximal end portion to the distal end portion.

20. The extender of claim 12, wherein the body portion comprises a monolithic structure.
